(19) United States
(12) Patent Application Publication
(10) Pub. No.: US 2012/0304441 A1
(43) Pub. Date: Dec. 6, 2012

(54) TABLE AND PRIVACY SCREEN ASSEMBLY

(75) Inventor: Jay M. Henriott, Jasper, IN (US)

(73) Assignee: KIMBALL INTERNATIONAL, INC., Jasper, IN (US)

(21) Appl. No.: 13/353,669

(22) Filed: Jan. 19, 2012

Related U.S. Application Data
(60) Provisional application No. 61/492,833, filed on Jun. 3, 2011.

(51) Int. Cl. A47B 37/00; B23P 11/00

(52) U.S. Cl. 29/428; 108/28

(57) ABSTRACT

A privacy screen mounting arrangement for an office system including a bracket which can be secured to a table assembly to clamp a privacy screen against an edge of a work surface of the table assembly. In a table assembly having a back-to-back arrangement of work surfaces with an opening between the work surfaces, a privacy screen mounting arrangement includes a bracket securable beneath one of the work surfaces, with a screen attached to the bracket such that the screen is generally disposed between and above the work surfaces. The mounting arrangements obviate the need to secure brackets directly to the top surface of a work surface using fasteners.

### CROSS-REFERENCE TO RELATED APPLICATIONS

The present application claims the benefit under Title 35, U.S.C. §119(e) of U.S. Provisional Patent Application Ser. No. 61/492,833, entitled TABLE AND PRIVACY SCREEN ASSEMBLY, filed on Jun. 3, 2011, the entire disclosure of which is expressly incorporated herein by reference.

### BACKGROUND

1. Field of the Disclosure

The present disclosure relates to office systems, and in particular to screens or dividers that may be mounted relative to work surfaces of an office system to provide for privacy.

2. Description of the Related Art

Office furniture systems include partition systems having a plurality of panels that form an interior space. The interior space may be utilized as an office or meeting room, for example, and may include tables, chairs, cabinets, and other items. Other office systems, such as desking systems, are more open and are based on modular table systems having work surfaces and storage units.

In either of the foregoing systems, privacy screens are often desired to provide a degree of privacy. Typically, such screens are disposed above work surface height at the eye level of a person seated at the work surface. One problem with known privacy screens is that the screens are mounted with brackets that are secured directly to the top surface of the work surfaces using fasteners, which mars or defaces the work surfaces.

What is desired is a privacy screen having a mounting arrangement which is an improvement over the foregoing.

### SUMMARY

The present disclosure provides a privacy screen mounting arrangement for an office system including a bracket which, in a first embodiment, can be secured to a table assembly to clamp a privacy screen against an edge of a work surface of the table assembly. In other embodiments, for use with a table assembly having a back-to-back arrangement of work surfaces with an opening between the work surfaces, the present disclosure provides a privacy screen mounting arrangement including a bracket which can be secured beneath one of the work surfaces, with a screen attached to the bracket such that the screen is generally disposed between and above the work surfaces. The mounting arrangements of the present disclosure obviate the need to secure brackets directly to the top surface of a work surface using fasteners.

The present disclosure, in one form thereof, provides a table assembly, including a table including at least one table leg assembly and a work surface, the work surface supported on the table leg assembly and including an edge; a screen including opposite interior and exterior faces and a lower edge; and a bracket, including a mounting portion attached to the table leg assembly; and an engagement portion extending from the mounting portion and adjacently spaced from the edge of the work surface; the lower edge of the screen received between the bracket and the edge of the work surface.

The present disclosure, in another form thereof, provides a back-to-back table assembly, including a first work surface and a second work surface, the first work surface and the second work surface having edges spaced from one another with an opening between the first work surface and the second work surface; a screen including opposite faces; and a bracket, including a mounting portion attached to a bottom surface of one of the first work surface and the second work surface; an engagement portion extending from the mounting portion, the engagement portion including a pair of side walls defining a screen receiving cavity; and the screen positioned within the screen receiving cavity and extending above the first work surface and the second work surface.

The present disclosure, in a further form thereof, provides a method of mounting a screen to a table including a work surface and a table leg assembly, the work surface including an edge, the method including the steps of: initially supporting a bracket with respect to the table leg assembly with the bracket movable in a horizontal direction relative to the work surface; positioning the screen between the bracket and the edge of the work surface; moving the bracket in the horizontal direction towards the edge of the work surface to clamp the screen against the edge of the work surface such that the screen is positioned between and abuts both the bracket and the edge of the work surface; and securing the bracket to the table leg assembly.

The present disclosure, in another form thereof, provides A method of attaching a screen relative to a first work surface and a second work surface, the work surfaces having edges spaced from one another with an opening between the edges of the first work surface and the second work surface, the method including the steps of: initially supporting a bracket with respect to one of the first work surface and the second work surface so that a screen receiving cavity of the bracket extends through the opening and above the work surfaces; moving the bracket in a horizontal direction relative to the work surfaces until a desired position of the screen receiving cavity of the bracket between the work surfaces is achieved; securing the bracket to one of the first work surface and the second work surface; and positioning the screen within the screen receiving cavity such that the screen is generally disposed between and above the first work surface and the second work surface.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a perspective view of an office partition system that includes a table assembly supporting a work surface, and a pair of brackets in accordance with a first embodiment of the present disclosure, the pair of brackets secured to the table assembly and clamping a screen against an edge of the work surface;

FIG. 2 is a perspective view of a bracket in accordance with a first embodiment of the present disclosure;

FIG. 3 is a lower fragmentary, perspective view of the table assembly of FIG. 1 supporting a work surface, and a pair of the brackets of FIG. 2 secured to the table assembly and clamping a screen against the work surface;

FIG. 4 is a cross-sectional view taken along line 4-4 of FIG. 3;

FIG. 5 is an upper fragmentary, perspective view of the table assembly of FIG. 1 supporting a work surface, and a pair of the brackets of FIG. 2 secured to the table assembly and clamping a screen against the work surface;

FIG. 6 is a detailed, fragmentary view of a portion of FIG. 5;

FIG. 7 is a perspective view of a table desking assembly including a back-to-back arrangement of work surfaces, brackets in accordance with second and third embodiments of the present disclosure, and screens mounted to the brackets;

FIG. 8 is a perspective view of a bracket in accordance with a second embodiment of the present disclosure;

FIG. 9 is a fragmentary, cross-sectional view of the back-to-back arrangement of work surfaces of FIG. 7, illustrating use of the bracket of FIG. 8 to mount a screen;

FIG. 10 is a perspective view of a bracket in accordance with a third embodiment of the present disclosure; and

FIG. 11 is a fragmentary, cross-sectional view of the back-to-back arrangement of work surfaces of FIG. 7, illustrating use of the bracket of FIG. 10 to mount a screen.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

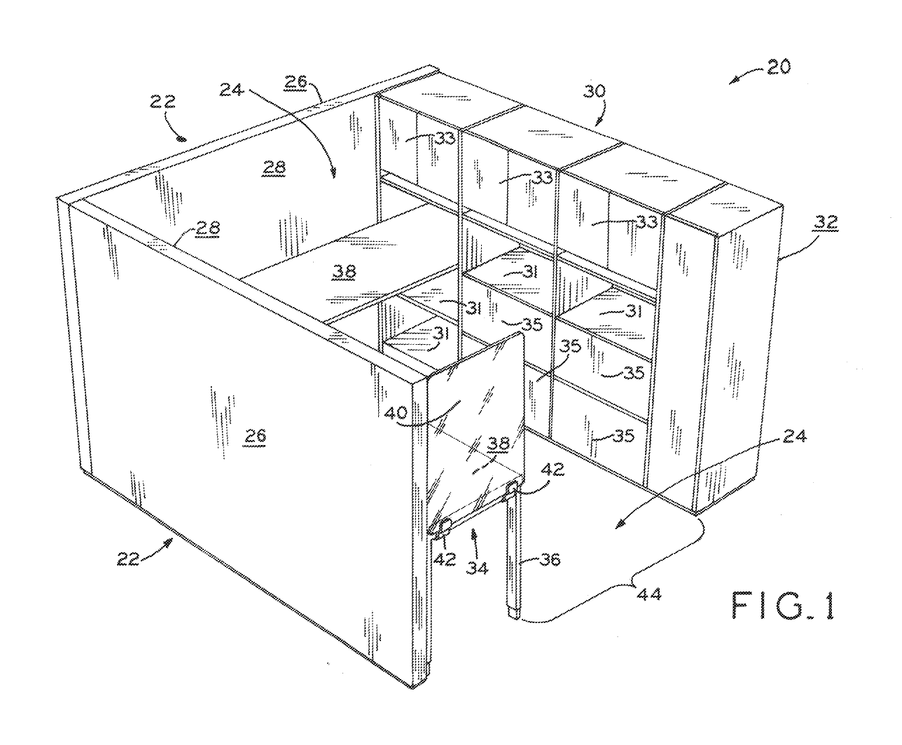

Referring to FIG. 1, office partition system 20 includes a plurality of partition system panels 22 that form interior office space 24. Exterior surfaces 26 of panels 22 face an opposing, exterior space of office partition system 20. The opposing, exterior space may be an interior space of another office partition system, in which case exterior surfaces 26 of panels 22 of FIG. 1 may also be interior surfaces for another interior office space (not shown) of another office partition system (not shown). Interior surfaces 28 of panels 22 face interior office space 24. Interior office space 24 may be part of an office space conference room, an office space for an individual office resident, an office space for two or more office residents, or other interior office space. Interior office space 24 may include office items such as a chair, a desk, cabinet units, drawer units, and/or shelving units. Referring to FIG. 1, shelving/cabinet assembly 30 and table assembly 34 including work surface 38 are shown within interior office space 24. Shelving/cabinet assembly 30 generally includes shelves 31, cabinets 33, drawers 35, and defines shelving/cabinet exterior panel wall or surface 32.

As discussed in further detail below, table assembly 34 generally includes table leg assembly 36, work surfaces 38, screen 40, and brackets 42. FIG. 1 illustrates a pair of brackets 42 which are secured to table leg assembly 36 and clamp screen 40 against an edge of work surface 38 in accordance with the present disclosure.

Referring to FIG. 1, exterior wall of panel surface 32 of shelving/cabinet assembly 30 and the panel 22 adjacent screen 40 together define opening 44 which provides an office resident access to interior office space 24. An office resident may desire a degree of privacy within interior office space 24, and a privacy screen, such as screen 40 shown in FIG. 1, can be used to provide additional privacy within interior office space 24.

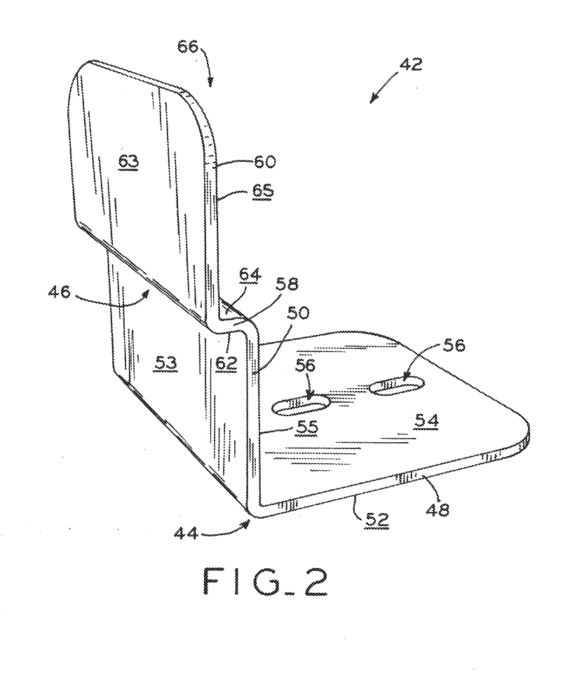

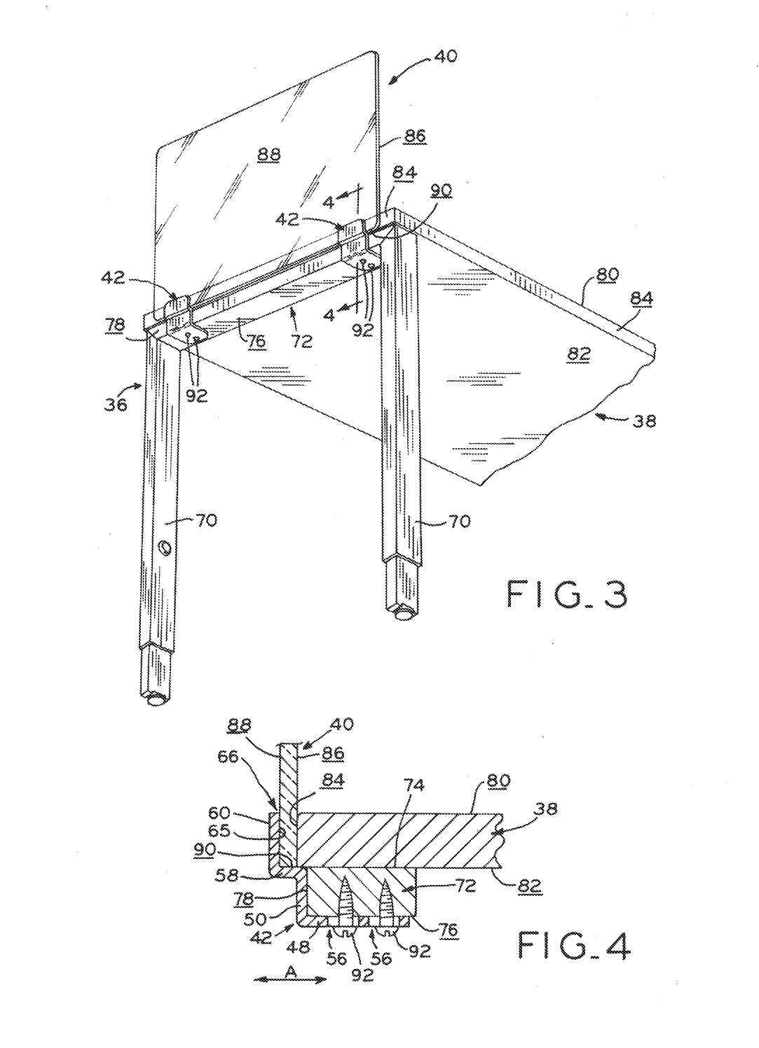

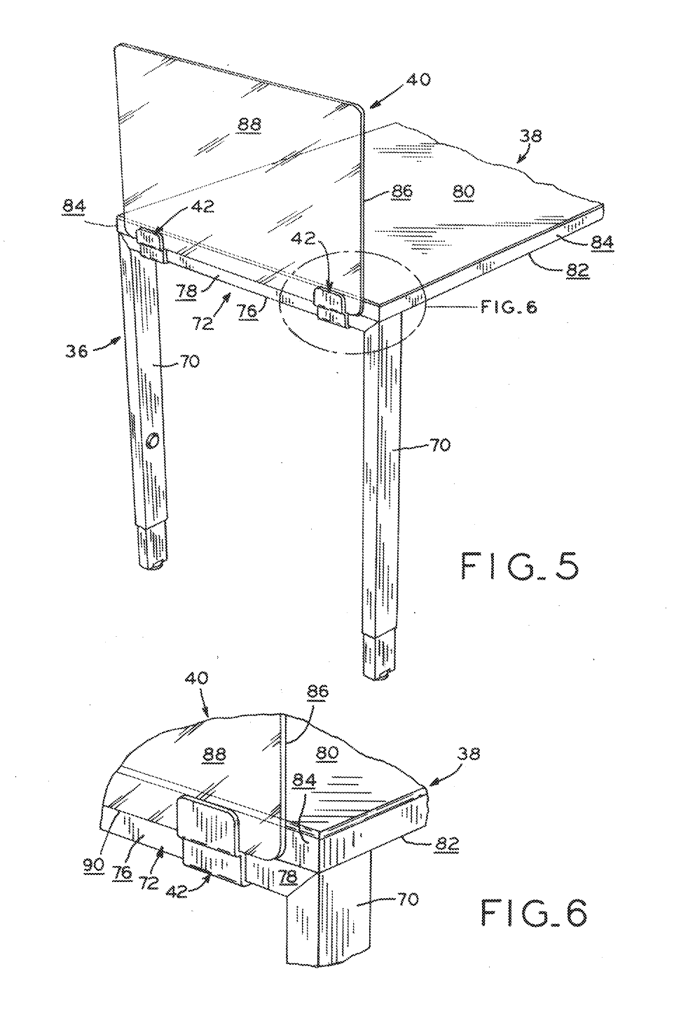

FIGS. 2-6 illustrate bracket 42, according to a first embodiment of the present disclosure, attached to table leg assembly 36 and clamping screen 40 against work surface 38. Referring to FIGS. 3-6, table leg assembly 36 generally includes a frame having two vertical table legs 70 and horizontal table leg support member 72 connecting table legs 70. Table legs 70 and table leg support member 72 together define a generally inverted U-shaped assembly. Table leg support member 72 generally includes work surface contacting surface 74 (FIG. 4), opposing bottom surface 76, and side surface 78 extending from work surface contacting surface 74 to bottom surface 76. Work surface 38 is supported on table leg support member 72 and generally includes top surface 80 which provides a table work surface for an office resident, opposing bottom surface 82, and side surface 84 extending from top surface 80 to bottom surface 82. Screen 40 generally includes opposite side faces 86, 88 and bottom edge surface 90 (FIGS. 4 and 6) extending between side faces 86, 88.

FIG. 2 illustrates bracket 42 according to a first embodiment of the present disclosure. Bracket 42 generally includes mounting portion 44 and engagement portion 46. Mounting portion 44 generally includes horizontal wall 48 and vertical wall 50. Horizontal wall 48 is sized and shaped to be attachable to bottom surface 76 of table leg support member 72 (FIGS. 3-6) and generally includes exterior surface 52, opposing table leg contacting surface 54, and a pair of fastener slots 56 extending between exterior surface 52 and table leg contacting surface 54.

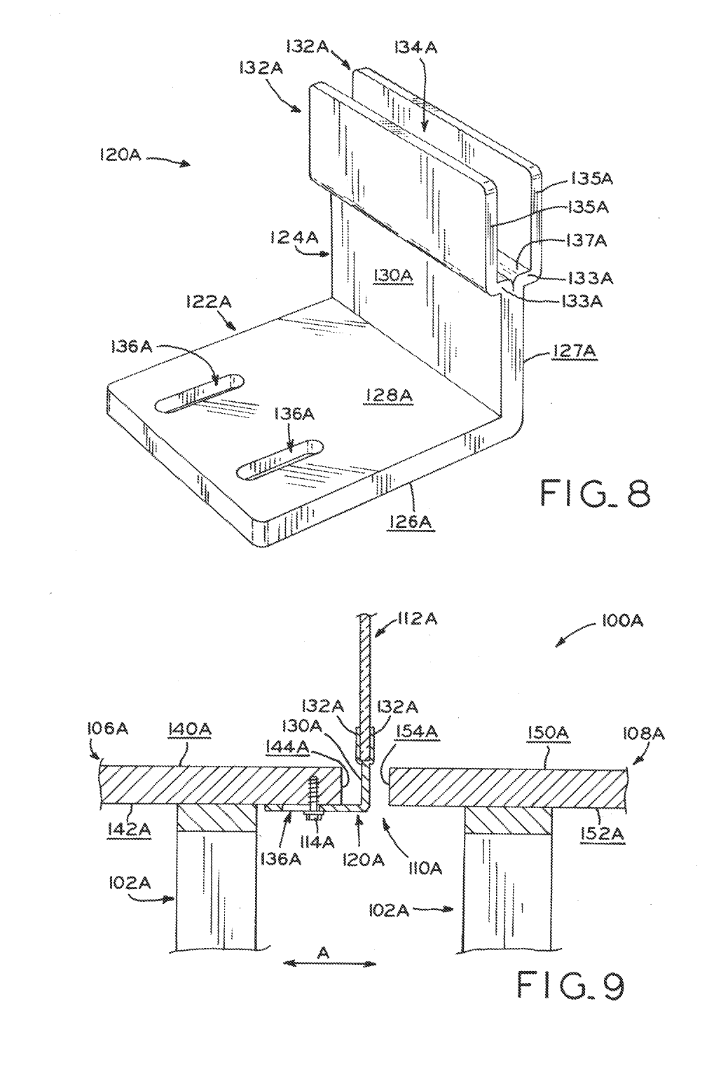

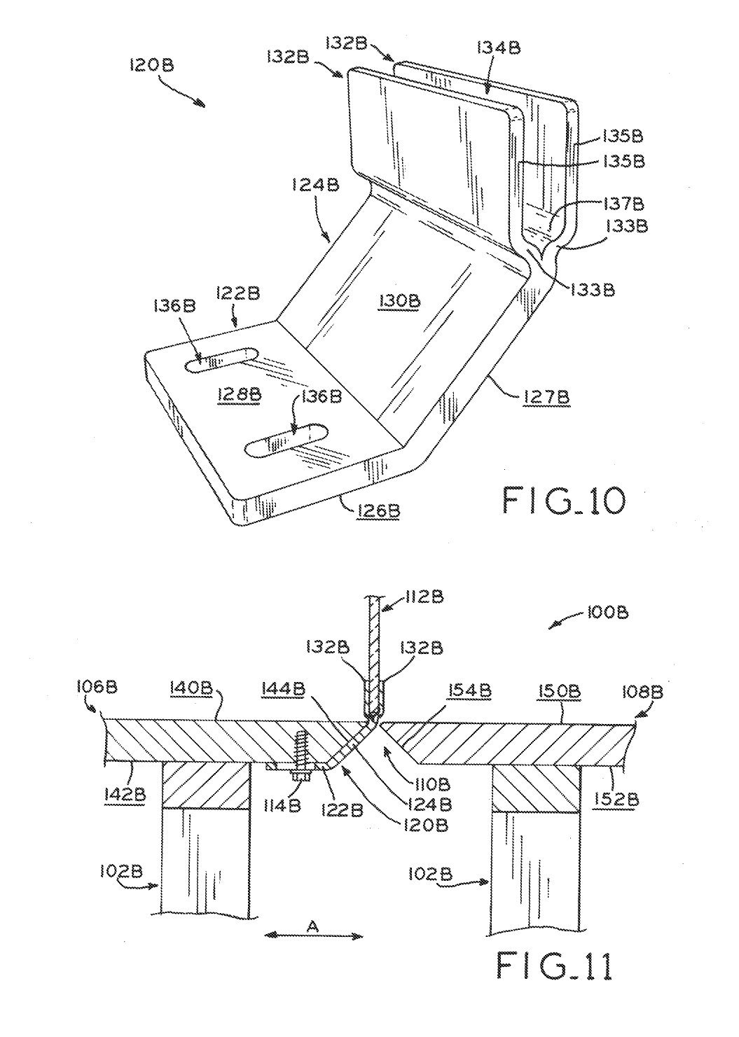

In one embodiment, referring to FIG. 2, fastener slots 56 are longitudinally aligned. In other embodiments, fastener slots 56 could be arranged in other configurations. For example, fastener slots 56 could be disposed in horizontal wall 48 in a side-by-side configuration similar to slots 136A, 136B of the embodiment illustrated in FIGS. 8 and 10, described below. In other embodiments, only one fastener slot 56, or more than two fastener slots 56, may be provided in mounting portion 44. Fastener slots 56 are sized and shaped to each receive a fastener such as screw fastener 92 (FIG. 4). Vertical wall 50 is sized and shaped to abut side surface 78 of table leg support member 72 (FIGS. 3-6) and extends upwardly from horizontal wall 48. In one embodiment, as illustrated in FIG. 2, vertical wall 50 extends perpendicularly from horizontal wall 48, such that horizontal wall 48 and vertical wall 50 together form a generally L-shape. Vertical wall 50 includes exterior surface 53 and opposing table leg contacting surface 55.

Engagement portion 46 of bracket 42 generally includes horizontal wall 58 and vertical wall 60. Horizontal wall 58 is sized and shaped to receive the lower edge of screen 40 (FIGS. 3-6) of a particular thickness and includes exterior surface 62 and opposing screen contacting surface 64. Vertical wall 60 is sized and shaped together with horizontal wall 58 to define screen receiving cavity 66 to receive screen 40 (FIGS. 3-6) of a particular thickness and includes exterior surface 63 and opposing screen contacting surface 65 (FIG. 2). Horizontal wall 58 extends perpendicularly from vertical wall 50 and is configured to receive bottom edge surface 90 (FIGS. 4 and 6) of screen 40 (FIGS. 3-6). Vertical wall 60 upwardly extends upwardly and perpendicularly from horizontal wall 58 and is sized and shaped to abut side face 88 of screen 40 (FIGS. 3-6).

Referring to FIGS. 3-6, an exemplary use of bracket 42 to secure screen 40 against work surface 38 will now be described. Referring to FIGS. 3-6, bracket 42 can be positioned relative to work surface 38 and table leg assembly 36 such that horizontal wall 48 of bracket 42 is positioned adjacent bottom surface 76 of table leg support member 72 and vertical wall 60 of bracket 42 is positioned adjacent side surface 84 of work surface 38 with a gap between screen contacting surface 65 (FIG. 2) of vertical wall 60 and side surface 84 of work surface 38. With bracket 42 so positioned relative to table leg support member 72 and work surface 38, fasteners 92 (FIG. 4) can be received in respective fastener slots 56 disposed in horizontal wall 48 and are initially only partially threaded into table leg support member 72 so that bracket 42 can be moved in a direction generally along arrow A (FIG. 4) to allow for some amount of horizontal movement of “play” of bracket 42 relative to work surface 38.

Next, screen 40 can be removably inserted into screen receiving cavity 66 such that bottom edge surface 90 (FIGS. 4 and 6) of screen 40 abuts screen contacting surface 64 (FIG. 2) of horizontal wall 58. With fasteners 92 only partially threaded into table leg support member 72, bracket 42 can be moved in a direction generally along arrow A (FIG. 4) to clamp screen 40 against work surface 38 and to provide a secure fit of screen 40 between screen contacting surface 65 (FIG. 2) of vertical wall 60 and side surface 84 of work surface 38 such that significant relative movement of screen 40 relative to bracket 42 and work surface 38 is prevented, i.e., screen 40 is captured between bracket 42 and work surface 38. Then fasteners 92 are completely or fully threaded into table leg support member 72 to secure bracket 42 to table leg support member 72 as shown in FIG. 4 and to clamp screen 40 firmly between bracket 42 and work surface 38. To remove screen 40 from screen receiving cavity 66 of bracket 42, fasteners 92 can be loosened so that bracket 42 can be moved in a direction generally along arrow A (FIG. 4) and screen 40 can be removed from screen receiving cavity 66.

Referring to FIGS. 2 and 4, a series of brackets can be provided in which the width of horizontal wall 58 is varied to adjust the width of screen receiving cavity 66 so that a bracket 42 can be selected and used to secure screens 40 having a variety of different screen thicknesses against work surface 38.

Further, the same bracket 42 can be used to secure screens 40 having a variety of different screen thicknesses against work surface 38. Referring to FIG. 4, bracket 42 is secured to table leg support member 72 to clamp screen 40 between bracket 42 and work surface 38. Bracket 42 could also be used to clamp a screen having a thickness greater than screen 40 between bracket 42 and work surface 38. For example, to clamp a screen having a thickness greater than screen 40 between bracket 42 and work surface 38, bracket 42 can be moved in a direction generally along arrow A (FIG. 4) before bracket 42 is secured to table leg support member 72 such that table leg contacting surface 55 (FIG. 2) of vertical wall 50 is spaced a distance from side surface 78 of table leg support member 72. In this manner, the distance between side surface 84 of work surface 38 and screen contacting surface 65 (FIG. 2) of vertical wall 60 is increased and a screen having a thickness greater than screen 40 can be inserted into screen receiving cavity 66. Next, bracket 42 could be moved in a direction generally along arrow A (FIG. 4) to clamp the screen having a thickness greater than screen 40 against work surface 38.

In one embodiment, as illustrated in FIG. 4, side surface 84 of work surface 38 extends beyond side surface 78 of table leg support member 72. In such a configuration, as illustrated in FIG. 4, the width of screen receiving cavity 66 is defined by the distance between screen contacting surface 65 of vertical wall 60 and side surface 84 of work surface 38. In this configuration, the width of screen receiving cavity 66 is less than the width of horizontal wall 58. In other embodiments, side surface 84 of work surface 38 can be aligned with side surface 78 of table leg support member 72 such that side surface 84 of work surface 38 and side surface 78 of table leg support member 72 together form a continuous planar surface. In such an embodiment, the lower edge of screen 40 may rest against wall 56 of bracket 42.

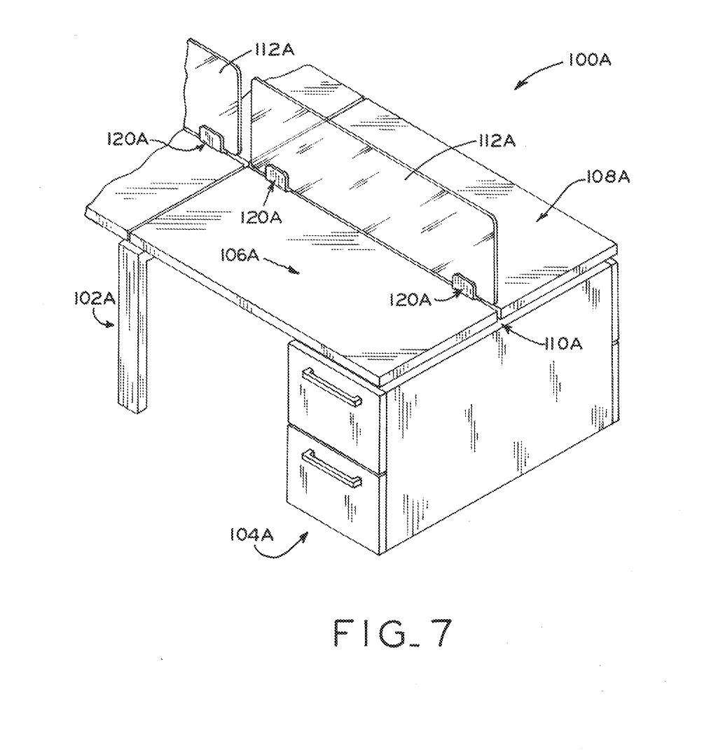

FIG. 7 illustrates back-to-back table desking assembly 100A. Back-to-back table assembly 100A generally includes table leg assembly 102A, cabinet assembly 104A, first work surface 106A, and second work surface 108A. In this embodiment, first work surface 106A and second work surface 108A are positioned such that space 110A is located between the mutually-facing rear edges of work surfaces 106A, 108A. As described below, the width of space 110A between work surfaces 106A, 108A can vary. Back-to-back table assembly 100A allows two office residents to work opposite each other at respective work surfaces 106A, 108A. In such a configuration, the office residents may desire a degree of privacy between work surfaces 106A, 108A, for which a privacy screen such as screen 112A may be used. Brackets 120A of the present disclosure can be used to secure screen 112A relative to work surfaces 106A, 108A in back-to-back table assembly 100A as will be discussed in more detail below.

Although described in connection with back-to-back table desking assemblies, the brackets of FIGS. 7-11 may also be used with individual tables for providing privacy in the manner described below.

Referring to FIG. 9, first work surface 106A generally includes top surface 140A, opposing bottom surface 142A, and side edge surface 144A extending from top surface 140A to bottom surface 142A. Second work surface 108A generally includes top surface 150A, opposing bottom surface 152A, and side edge surface 154A extending from top surface 150A to bottom surface 152A.

FIG. 8 illustrates a bracket, according to a second embodiment, for use with back-to-back table assembly 100A. Bracket 120A generally includes mounting wall 122A, vertical wall 124A, and a pair of opposing screen support walls 132A defining screen receiving cavity 134A. Mounting wall 122A is sized and shaped to be attachable to bottom surface 142A of 152A of a respective work surface 106A, 108A and generally includes exterior surface 126A, opposing interior surface 128A, and elongated slots 136A extending between exterior surface 126A and interior surface 128A.

In one embodiment, referring to FIG. 8, elongated slots 136A extend parallel to one another. In other embodiments, elongated slots 136A could be arranged in other configurations. For example, slots 136A could be disposed in mounting wall 122A in a configuration similar to slots 56 as illustrated in connection with the first embodiment of FIG. 2. In other embodiments, only one slot 136A may be provided in mounting wall 122A. In alternate embodiments, three or more slots 136A may be provided in mounting wall 122A. Slots 136A are sized and shaped to receive a fastener such as screw fastener 114A (FIG. 9). Referring to FIGS. 8 and 9, slots 136A are elongated to allow for adjustment of the position of bracket 120A before final securement of the bracket 120A to first work surface 106A via fasteners 114A.

Referring to FIG. 8, vertical wall 124A is sized and shaped to optionally abut side surface 144A, 154A of a work surface 106A, 108A and generally includes exterior surface 127A and opposing interior surface 130A. Vertical wall 124A perpendicularly extends from mounting wall 122A. Referring to FIG. 8, at an end of vertical wall 124A opposite the end where vertical wall 124A meets mounting wall 122A, opposing screen support walls 132A extend from vertical wall 124A. Screen support walls 132A are sized and shaped to define screen receiving cavity 134A to receive screen 112A (FIG. 9) of a particular thickness and each generally include horizontal wall 133A and vertical wall 135A. Horizontal walls 133A perpendicularly extend from vertical wall 124A and together define cavity bottom wall 137A. Vertical walls 135A perpendicularly extend from respective horizontal walls 133A. Horizontal walls 133A and vertical walls 135A of respective screen support walls 132A together define screen receiving cavity 134A having cavity bottom wall 137A.

Referring to FIG. 8, a series of brackets 120A can be provided in which the width of horizontal walls 133A are varied to adjust the width of screen receiving cavity 134A so that a bracket 120A can be selected and used to insert screens 112A (FIG. 9) having a variety of different thicknesses into screen receiving cavity 134A.

Referring to FIG. 9, an exemplary use of bracket 120A to secure screen 112A relative to work surfaces 106A, 108A in back-to-back table assembly 100A will now be described. Bracket 120A can be positioned relative to first work surface 106A such that interior surface 128A of mounting wall 122A is positioned adjacent bottom surface 142A of first work surface 106A, and interior surface 130A of vertical wall 124A is positioned between side surface 144A of first work surface 106A and side surface 154A of second work surface 108A. In this manner, bracket 120A is positioned relative to work surfaces 106A, 108A such that opposing screen support walls 132A extend from space 110A between work surfaces 106A, 108A and are disposed above top surface 140A of first work surface 106A and top surface 150A of second work surface 108A.

With bracket 120A so positioned relative to work surfaces 106A, 108A, fasteners 114A (only one of which can be seen in FIG. 9) can be received in respective slots 136A disposed in mounting wall 122A and are initially only partially threaded into first work surface 106A so that bracket 120A can be moved in a direction generally along arrow A (FIG. 9) to allow for some amount of horizontal “play” of bracket 120A relative to work surfaces 106A, 108A. In this manner, the position of screen receiving cavity 134A (FIG. 8) of bracket 120A relative to work surfaces 106A, 108A can be adjusted and controlled as desired. For example, screen receiving cavity 134A (FIG. 8) of bracket 120A can be centered in space 110A between work surfaces 106A, 108A, or alternatively, can be placed in an off-center arrangement to provide clearance for wiring or other items. In one embodiment, as illustrated in FIG. 9, interior surface 130A of vertical wall 124A is spaced a distance from side surface 144A of first work surface 106A. In other embodiments, interior surface 130A of vertical wall 124A (FIG. 8) could abut side surface 144A of first work surface 106A. Once screen receiving cavity 134A (FIG. 8) of bracket 120A is positioned in a desired location between work surfaces 106A, 108A, fasteners 114A are completely threaded into first work surface 106A to secure bracket 120A to first work surface 106A as shown in FIG. 9, such that the position of bracket 120A is fixed relative to first work surface 106A. Next, screen 112A can be inserted into screen receiving cavity 134A (FIG. 8) of bracket 120A as shown in FIG. 9 with a friction fit, for example. In alternative embodiments, a set screw can be inserted through a bore in screen support wall 132A until the set screw contacts screen 112A to further secure screen 112A within screen receiving cavity 134A (FIG. 8).

FIG. 11 illustrates another exemplary embodiment of a back-to-back table assembly, e.g., back-to-back table assembly 100B. In this embodiment, side surfaces 144B, 154B of work surfaces 106B, 108B include a chamfered edge. FIG. 10 illustrates a bracket, according to a third embodiment, for use with back-to-back table assembly 100B.

Referring to FIG. 10, bracket 120B generally includes mounting wall 122B, chamfer wall 124B, and opposing screen support walls 132B defining screen receiving cavity 134B. Mounting wall 122B is sized and shaped to be attachable to bottom surface 142B, 152B of a work surface 106B, 108B and generally includes interior surface 128B, opposing exterior surface 126B, and defines elongated slots 136B extending between interior surface 128B and exterior surface 126B.

In one embodiment, referring to FIG. 10, slots 136B extend parallel to one another. In other embodiments, slots 136B could be arranged in other configurations. For example, slots 136B could be disposed in mounting wall 122B in a configuration similar to slots 56 as illustrated in connection with the first embodiment of FIG. 2. In other embodiments, only one slot 136B may be provided in mounting wall 122B. In alternate embodiments, three or more slots 136B may be provided in mounting wall 122B. Slots 136B are sized and shaped to receive a fastener such as fastener 114B (FIG. 11). Referring to FIGS. 10 and 11, slots 136B are elongated to allow for adjustment of the position of bracket 120B before final securement to first work surface 106B via fasteners 114B.

Referring to FIG. 10, chamfer wall 124B is sized and shaped to optionally abut side edge surface 144B, 154B of a work surface 106B, 108B and generally includes exterior surface 127B and interior surface 130B. Chamfer wall 124B extends from mounting wall 122B at an angle. The angle at which chamfer wall 124B extends from mounting wall 122B can be varied depending on the angle of chamfer of side surface 144B, 154B of a work surface 106B, 108B. In this manner, brackets 120B can be used to secure screen 112B relative to work surfaces 106B, 108B for a variety of different angles of chamfered side edge surfaces of a work surface. Referring to FIG. 10, at an end of chamfer wall 124B opposite the end where chamfer wall 124B meets mounting wall 122B, opposing screen support walls 132B extend from chamfer wall 124B. Screen support walls 132B are sized and shaped to define screen receiving cavity 134B to receive screen 112B (FIG. 11) of a particular thickness and each generally include horizontal wall 133B and vertical wall 135B. Horizontal walls 133B perpendicularly extend from chamfer wall 124B and together define cavity bottom wall 137B. In other embodiments, horizontal walls 133B can extend from chamfer wall 124B at other desired angles. Vertical walls 135B perpendicularly extend from respective horizontal walls 133B. Horizontal walls 133B and vertical walls 135B of respective screen support walls 132B together define screen receiving cavity 134B having cavity bottom wall 137B.

Referring to FIG. 10, a series of brackets 120B can be provided in which the width of horizontal walls 133B are varied to adjust the width of screen receiving cavity 134B so that a bracket 120B can be selected and used to insert screens 112B (FIG. 11) having a variety of different thicknesses into screen receiving cavity 134B.

Referring to FIG. 11, an exemplary use of bracket 120B to secure screen 112B relative to work surfaces 106B, 108B in back-to-back table assembly 100B will now be described. Bracket 120B can be positioned relative to first work surface 106B such that interior surface 128B (FIG. 10) of mounting wall 122B is positioned adjacent bottom surface 142B of first work surface 106B, and interior surface 130B (FIG. 10) of chamfer wall 124B is positioned between side surface 144B of first work surface 106B and side surface 154B of second work surface 108B. In this manner, bracket 120B is positioned relative to work surfaces 106B, 108B such that opposing screen support walls 132B extend from space 110B between work surfaces 106B, 108B and are disposed above top surface 140B of first work surface 106B and top surface 150B of second work surface 108B.

With bracket 120B so positioned relative to work surfaces 106B, 108B, fasteners 114B (only one of which can be seen in FIG. 11) can be received in respective slots 136B disposed in mounting wall 122B and are initially only partially threaded into first work surface 106B so that bracket 120B can be moved in a direction generally along arrow A (FIG. 11) to allow for some amount of horizontal “play” of bracket 120B relative to work surfaces 106B, 108B. In this manner, the position of screen receiving cavity 134B (FIG. 10) of bracket 120B relative to work surfaces 106B, 108B can be adjusted and controlled as desired. For example, screen receiving cavity 134B (FIG. 10) of bracket 120B can be centered in space 110B between work surfaces 106B, 108B.

In one embodiment, as illustrated in FIG. 11, interior surface 130B (FIG. 10) of chamfer wall 124B abuts side surface 144B of first work surface 106B. In other embodiments, interior surface 130B (FIG. 10) of chamfer wall 124B can be located a distance from side surface 144B of first work surface 106B. Once screen receiving cavity 134B (FIG. 10) of bracket 120B is positioned in a desired location between work surfaces 106B, 108B, fasteners 114B are completely threaded into first work surface 106B to secure bracket 120B to first work surface 106B as shown in FIG. 11, such that the position of bracket 120B is fixed relative to first work surface 106B. Next, screen 112B can be inserted into screen receiving cavity 134B (FIG. 10) of bracket 120B as shown in FIG. 11 with a friction fit, for example. In alternative embodiments, a set screw can be inserted through a bore in screen support wall 132B until the set screw contacts screen 112B to further secure screen 112B within screen receiving cavity 134B (FIG. 10).

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A table assembly, comprising:
a table including at least one table leg assembly and a work surface, said work surface supported on said table leg assembly and including an edge;
a screen including opposite interior and exterior faces and a lower edge; and
a bracket, comprising:
a mounting portion attached to said table leg assembly; and
an engagement portion extending from said mounting portion and adjacently spaced from said edge of said work surface;
said lower edge of said screen received between said bracket and said edge of said work surface.

2. The table assembly of claim 1, wherein said mounting portion of said bracket is attached to said table leg assembly via at least one fastener, each said fastener received within a slot in said mounting portion of said bracket.

3. The table assembly of claim 1, wherein said mounting portion includes a horizontal wall and a vertical wall, said horizontal wall attached to a bottom surface of said table leg assembly, said vertical wall extending from said horizontal wall.

4. The table assembly of claim 3, wherein said edge of said work surface extends beyond said table leg assembly.

5. The table assembly of claim 4, wherein said engagement portion of said bracket includes a horizontal wall and a vertical wall, said horizontal wall extending from said vertical wall of said mounting portion and in abutment with said bottom edge of said screen, said vertical wall of said engagement portion extending from said horizontal wall of said engagement portion, said vertical wall of said engagement portion in abutment with said exterior face of said screen.

6. The table assembly of claim 1, wherein said table leg assembly has an inverted U-shape.

7. A back-to-back table assembly, comprising:
a first work surface and a second work surface, said first work surface and said second work surface having edges spaced from one another with an opening between said first work surface and said second work surface;
a screen including opposite faces; and
a bracket, comprising:
a mounting portion attached to a bottom surface of one of said first work surface and said second work surface;
an engagement portion extending from said mounting portion, said engagement portion including a pair of side walls defining a screen receiving cavity; and
said screen positioned within said screen receiving cavity and extending above said first work surface and said second work surface.

8. The back-to-back table assembly of claim 7, wherein said engagement portion extends through said opening between said first work surface and said second work surface, with at least a portion of said engagement portion disposed above said first work surface and said second work surface.

9. The back-to-back table assembly of claim 7, wherein said engagement portion includes a vertical wall disposed perpendicular to said mounting portion.

10. The back-to-back table assembly of claim 7, wherein said engagement portion includes a wall extending from said mounting portion at a non-perpendicular angle with respect to said mounting portion.

11. A method of mounting a screen to a table including a work surface and a table leg assembly, the work surface including an edge, the method comprising the steps of:
initially supporting a bracket with respect to the table leg assembly with the bracket movable in a horizontal direction relative to the work surface;
positioning the screen between the bracket and the edge of the work surface;
moving the bracket in the horizontal direction towards the edge of the work surface to clamp the screen against the edge of the work surface such that the screen is positioned between and abuts both the bracket and the edge of the work surface; and
securing the bracket to the table leg assembly.

12. The method of claim 11, wherein the bracket includes a slot and wherein said step of initially supporting the bracket with respect to the table leg further comprises inserting a fastener through the slot of the bracket and initially threading the fastener into the table leg assembly such that the bracket can move in the horizontal direction relative to the work surface.

13. The method of claim 12, wherein said step of securing the bracket to the table leg assembly further comprises completely threading the fastener into the table leg such that the bracket is fixed relative to the work surface.

14. A method of attaching a screen relative to a first work surface and a second work surface, the work surfaces having edges spaced from one another with an opening between the edges of the first work surface and the second work surface, the method comprising the steps of:
initially supporting a bracket with respect to one of the first work surface and the second work surface so that a screen receiving cavity of the bracket extends through the opening and above the work surfaces;
moving the bracket in a horizontal direction relative to the work surfaces until a desired position of the screen receiving cavity of the bracket between the work surfaces is achieved;
securing the bracket to one of the first work surface and the second work surface; and
positioning the screen within the screen receiving cavity such that the screen is generally disposed between and above the first work surface and the second work surface.

15. The method of claim 14, wherein the bracket includes a slot and wherein said step of initially supporting the bracket with respect to one of the first work surface and the second work surface further comprises inserting a fastener through the slot of the bracket and initially threading the fastener into one of the first work surface and the second work surface such that the bracket can move in the horizontal direction relative to the work surfaces.

16. The method of claim 15, wherein said step of securing the bracket to one of the first work surface and the second work surface further comprises completely threading the fastener into one of the first work surface and the second work surface such that the bracket is fixed relative to the work surfaces.

17. The method of claim 14, wherein said step of moving the bracket in the horizontal direction relative to the work surfaces further comprises moving the bracket until the bracket abuts one of the first work surface and the second work surface.

18. The method of claim 14, wherein said step of moving the bracket in the horizontal direction relative to the work surfaces further comprises moving the bracket until the bracket is spaced a distance from each of the first work surface and the second work surface.

19. The method of claim 18, wherein said step of moving the bracket in the horizontal direction relative to the work surfaces further comprises moving the bracket until the bracket is centered in the opening between the first work surface and the second work surface.
